(19) United States
(12) Patent Application Publication
(10) Pub. No.: US 2020/0167456 A1
(43) Pub. Date: May 28, 2020

(54) DEVICE AND CONTROL METHOD FOR BIOMETRIC AUTHENTICATION

(71) Applicant: FUJITSU CONNECTED TECHNOLOGIES LIMITED, Yamato-shi (JP)

(72) Inventor: Kazuyuki Sato, Kawasaki (JP)

(73) Assignee: FUJITSU CONNECTED TECHNOLOGIES LIMITED, Yamato-shi (JP)

(21) Appl. No.: 16/716,756

(22) Filed: Dec. 17, 2019

Related U.S. Application Data
(63) Continuation of application No. PCT/JP2018/022211, filed on Jun. 11, 2018.

(30) Foreign Application Priority Data
Jun. 23, 2017 (JP) 2017-123263

(51) Int. Cl. G06F 21/32; G06F 21/34

(52) U.S. Cl. CPC G06F 21/32; G06F 21/34

(57) ABSTRACT

An information processing device includes a sensor, a memory and a processor. The processor is coupled to the memory. The processor is configured to perform control such that some biometric authentication devices of a plurality of biometric authentication devices are not activated at start of execution of biometric authentication on a basis of detection information detected by the sensor and activates remaining biometric authentication devices except the some biometric authentication devices of the plurality of biometric authentication devices and execute the biometric authentication using the remaining biometric authentication devices.

### CROSS-REFERENCE TO RELATED APPLICATIONS

This application is a continuation application of International Application PCT/JP2018/022211 filed on Jun. 11, 2018 and designated the U.S., and this application is based upon and claims the benefit of priority of the prior Japanese Patent Application No. 2017-123263 filed on Jun. 23, 2017, the entire contents of which are incorporated herein by reference.

### FIELD

The embodiments discussed herein are related to an information processing device and a biometric authentication control method.

### BACKGROUND

In recent years, an information processing devices equipped with biometric authentication devices has been widely used as awareness of security measures increases, and the price of the biometric authentication device decreases. Furthermore, for example, an information processing device is provided which includes a plurality of biometric authentication devices such as an iris authentication device and a fingerprint authentication device and can perform authentication by a plurality of authentication methods.

### DOCUMENTS OF RELATED ART

### Patent Document

[Patent document 1] Japanese Laid-open Patent Publication No. 2005-235236

### SUMMARY

An information processing device includes a sensor, a memory and a processor. The processor is coupled to the memory. The processor is configured to perform control such that some biometric authentication devices of a plurality of biometric authentication devices are not activated at start of execution of biometric authentication on a basis of detection information detected by the sensor and activates remaining biometric authentication devices except the some biometric authentication devices of the plurality of biometric authentication devices and execute the biometric authentication using the remaining biometric authentication devices.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIGS. 1A and 1B are diagrams illustrating an exemplary information processing device;

FIGS. 2A, 2B and 2C are diagrams for explaining an authentication process according to an authentication setting;

FIG. 3 is a diagram illustrating an example of a block configuration of an information processing device according to one embodiment;

FIGS. 4A and 4B are diagrams for explaining the time for exemplary iris authentication and fingerprint authentication;

FIG. 5 is a diagram illustrating an example of a guide for eye alignment during iris authentication;

FIG. 6 is a diagram illustrating an example of a relationship between a situation at the start of iris authentication execution and authentication performance;

FIG. 7 is a diagram illustrating an example of the relationship between a glove and fingerprint authentication;

FIGS. 8A and 8B are diagrams illustrating an example of authentication setting according to the embodiment;

FIG. 9 is a diagram illustrating an example of condition information;

FIGS. 10A and 10B are diagrams illustrating an example of setting of a glove mode;

FIG. 11 is a diagram illustrating an example of schedule information;

FIG. 12 is a diagram illustrating an example of an authentication process according to a first embodiment;

FIG. 13 is a diagram illustrating an example of a power saving determination process according to the embodiment;

FIGS. 14A and 14B are diagrams illustrating an example of notification information;

FIGS. 15A and 15B are diagrams illustrating an example of a guide;

FIGS. 16A and 16B are diagrams illustrating an example of an authentication process according to a second embodiment; and

FIG. 17 is a diagram illustrating an example of a hardware configuration of a computer for realizing the information processing device according to the embodiment.

### DESCRIPTION OF EMBODIMENTS

For example, a plurality of biometric authentication devices included in the information processing device is activated at the start of authentication, and the authentication is executed by any of the biometric authentication devices selected by a user. However, when the plurality of biometric authentication devices is activated, the biometric authentication devices that are not used for authentication also consume power, and thus power consumption increases.

In one aspect, an object of the embodiments is to suppress power consumption during authentication in an information processing device including a plurality of biometric authentication devices.

Hereinafter, some embodiments will be described in detail with reference to the drawings. Incidentally, the corresponding element in a plurality of drawings is denoted by the same reference numeral.

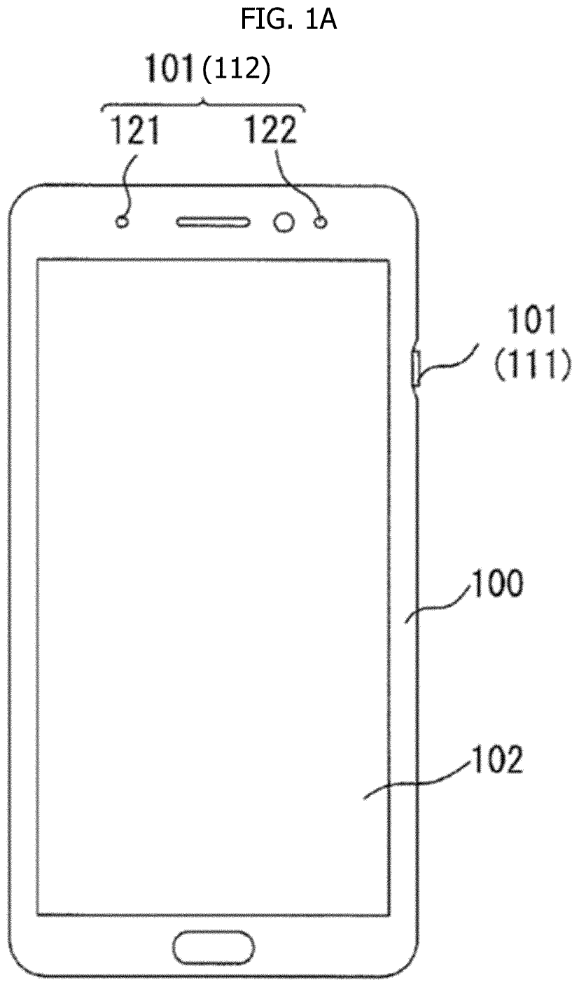

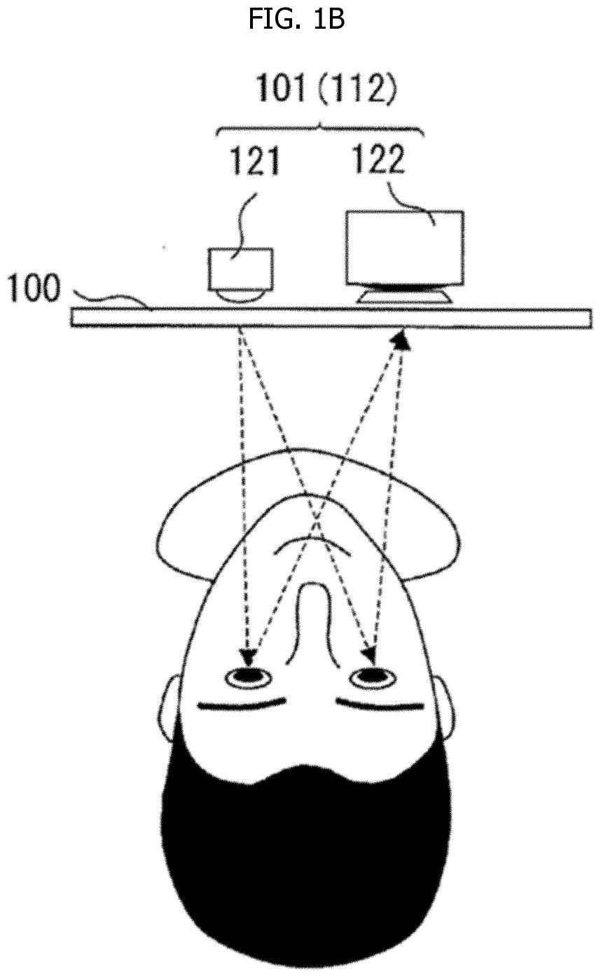

FIGS. 1A and 1B are diagrams illustrating an exemplary information processing device 100. For example, the information processing device 100 is a device that executes biometric authentication of a smartphone, a mobile phone, a tablet terminal, a personal computer (PC), a notebook PC, or the like. For example, the information processing device 100 includes a plurality of biometric authentication devices 101. For example, the biometric authentication device 101 is a device that collects biometric information such as fingerprint and iris information used for biometric authentication. In the example illustrated in FIG. 1A, the information processing device 100 includes a fingerprint authentication device 111 and an iris authentication device 112 as the biometric authentication device 101. The iris authentication device 112 includes, for example, an infrared light emitting diode (IR LED) 121 and an imaging device 122. The infrared light emitting diode 121 emits infrared light. In one example, the imaging device 122 is an infrared camera, includes a sensor that detects infrared light, and captures an image of the infrared light. Then, for example, as illustrated in FIG. 1B, the iris authentication device 112 irradiates the eyes of the user with infrared light using the infrared light emitting diode 121, and images the reflected light with the imaging device 122 to obtain an iris image. The information processing device 100 may execute biometric authentication using biometric information such as fingerprint information acquired by the fingerprint authentication device 111 and iris information acquired by the iris authentication device 112. In addition, in one embodiment, the information processing device 100 may include a touch panel 102.

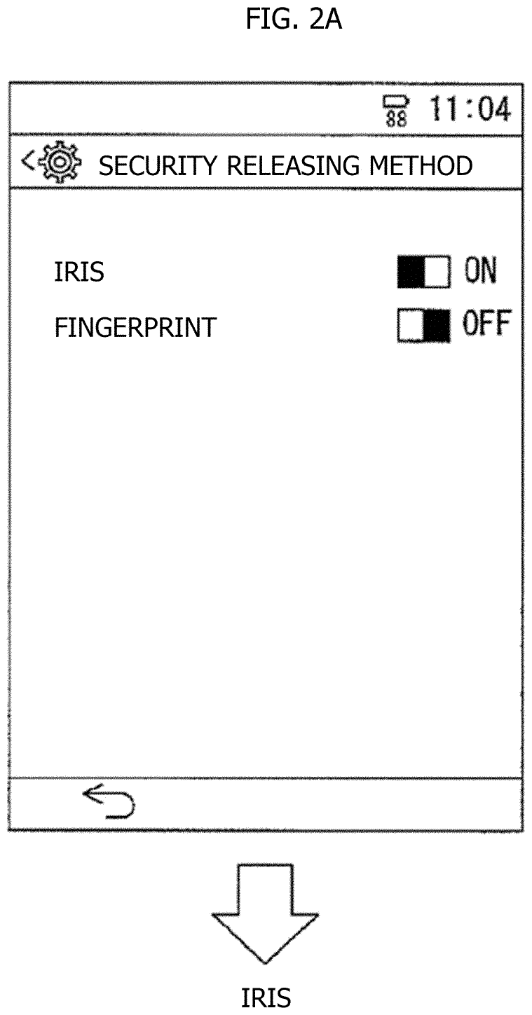

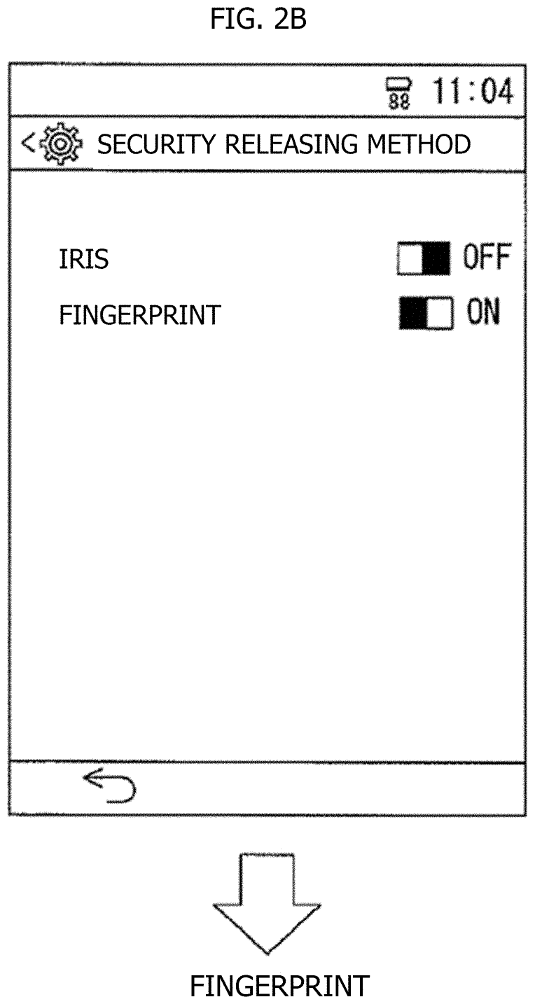

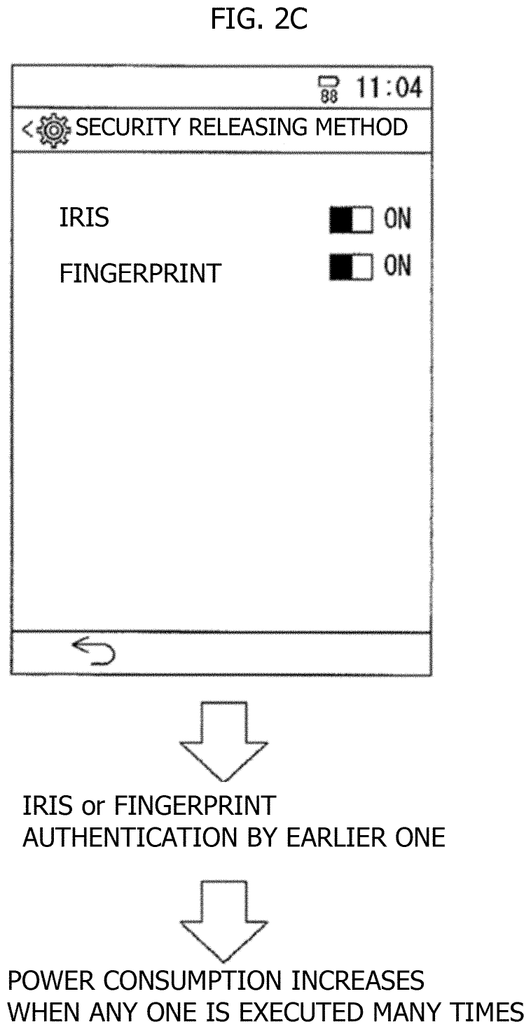

FIGS. 2A, 2B and 2C are diagrams illustrating authentication setting in the information processing device 100 including the plurality of biometric authentication devices 101 and authentication process according to the authentication setting. FIGS. 2A, 2B and 2C illustrate an example of an authentication setting screen of the information processing device 100, and the user can switch ON and OFF of the iris authentication and the fingerprint authentication on the authentication setting screen. For example, in FIG. 2A, only iris authentication is set to ON, and in this case, the information processing device 100 activates only the iris authentication device 112 and executes iris authentication using the iris authentication device 112. On the other hand, in FIG. 2B, for example, only fingerprint authentication is set to ON. In this case, the information processing device 100 activates only the fingerprint authentication device 111 and executes fingerprint authentication using the fingerprint authentication device 111. In FIG. 2C, both iris authentication and fingerprint authentication are set to ON. In this case, the information processing device 100 activates both the iris authentication device 112 and the fingerprint authentication device 111, and the biometric authentication device 101 of any authentication performed earlier is used to complete the authentication. By activating the plurality of biometric authentication devices 101, for example, the user can select an authentication method according to the situation, and convenience for the user is improved.

However, when the plurality of biometric authentication devices 101 is activated for authentication, each biometric authentication device 101 consumes power, and thus power consumption increases accordingly. Further, when the authentication process is repeatedly executed, the influence of the power consumed by the authentication on the remaining battery power becomes greater.

On the other hand, the information processing device 100 is desired to be driven for a long time. In addition, for example, women tend to seek small and lightweight terminals, and the size of the battery may be limited to meet such needs. Under these circumstances, further power saving of the information processing device 100 is desired. Therefore, it is desired to provide a technique capable of suppressing power consumption during authentication in the information processing device 100 including the plurality of biometric authentication devices 101.

Therefore, in the embodiment described below, the information processing device 100 including the plurality of biometric authentication devices 101 performs control such that some of the biometric authentication devices 101 are not activated at the start of the execution of biometric authentication on the basis of the detection information detected by the sensor. Then, the information processing device 100 activates the remaining biometric authentication devices 101 excluding some biometric authentication devices 101 among the plurality of biometric authentication devices 101 and executes biometric authentication. Here, some biometric authentication devices 101 of which the activation is suppressed may be, for example, a biometric authentication device 101 in which the quality of biometric information collected in a situation estimated from detection information detected by a sensor may be deteriorated to reduce the authentication rate or to prolong the time for authentication. Further, by causing the biometric authentication device 101 not to be activated, it is possible to suppress that the biometric authentication device 101 of which the authentication performance is deteriorated is activated to waste power. Hereinafter, the embodiment will be described in more detail.

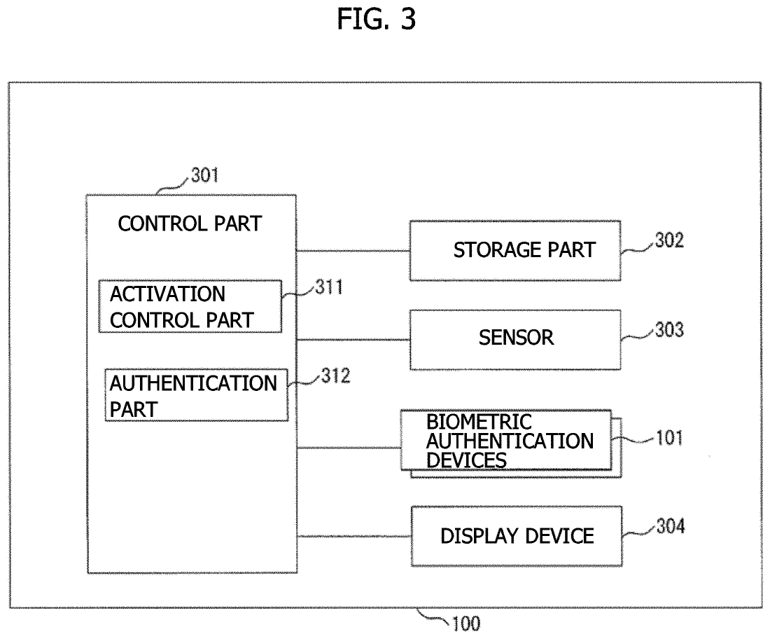

FIG. 3 is a diagram illustrating an example of a block configuration of the information processing device 100 according to one embodiment. For example, the information processing device 100 includes a control part 301, a storage part 302, a sensor 303, the plurality of biometric authentication devices 101, and a display device 304. The control part 301 operates as, for example, an activation control part 311 and an authentication part 312. For example, the storage part 302 of the information processing device 100 stores information such as authentication setting information 800, condition information 900, mode setting information 1000, and schedule information 1100, which will be described later. The sensor 303 may include, for example, an acceleration sensor or an illuminance sensor, and collects information for determining whether or not the biometric authentication device 101 is activated. The display device 304 may be a display, for example, and may display information on a display screen. Details of these parts and further details of information stored in the storage part 302 will be described later.

Next, features according to the type of biometric authentication method will be described. Various types of biometric authentication methods are known, but the characteristics are different for each type. For example, the iris authentication has an advantage that the time for the authentication is short and the authentication can be performed at a higher speed than the fingerprint authentication.

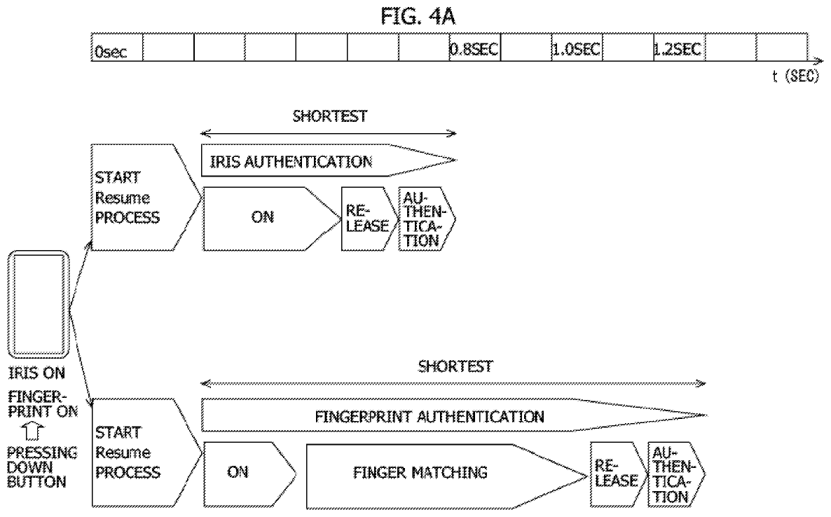

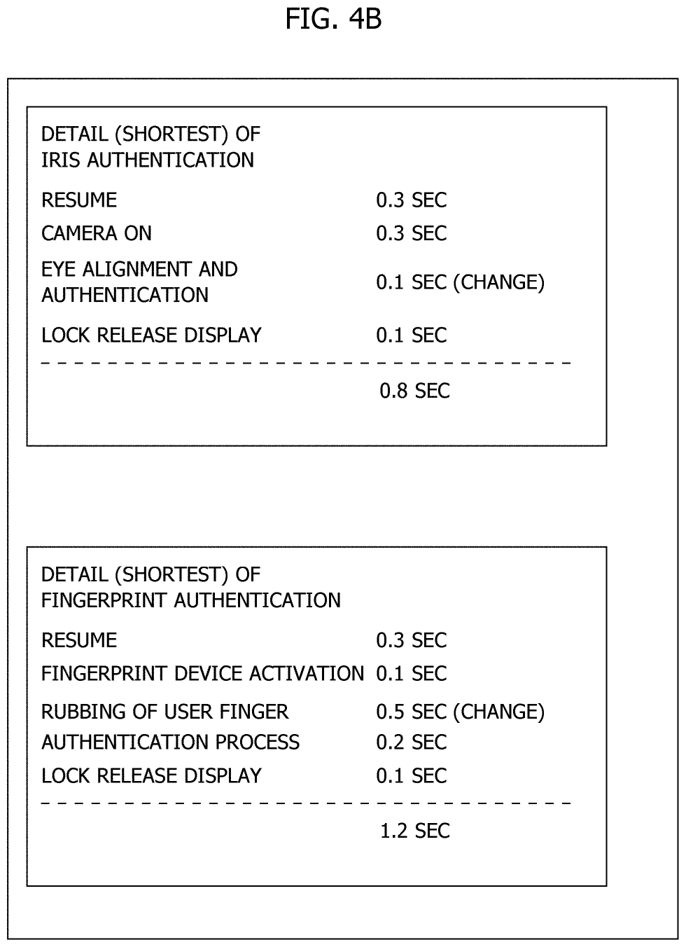

FIGS. 4A and 4B are diagrams for explaining the time for exemplary iris authentication and fingerprint authentication. As illustrated in FIGS. 4A and 4B, the control part 301 of the information processing device 100 starts a resume process by activation of pressing a power button, for example. The resume process is a process that is performed until the processor is activated from standby. Thereafter, in the iris authentication, the iris authentication device 112 is activated, executes eye alignment and authentication process, and releases lock when authentication is successful. In the iris authentication, for example, the authentication can be completed in about 0.8 seconds at the shortest until the authentication is completed. On the other hand, in the fingerprint authentication device 111, after the resume process, the fingerprint authentication device 111 is activated, executes finger matching, performs authentication, and releases the lock when authentication is successful. In the fingerprint authentication, for example, the authentication can be completed in about 1.2 seconds at the shortest until the authentication is completed. Thus, the iris authentication takes less time for authentication than the fingerprint authentication.

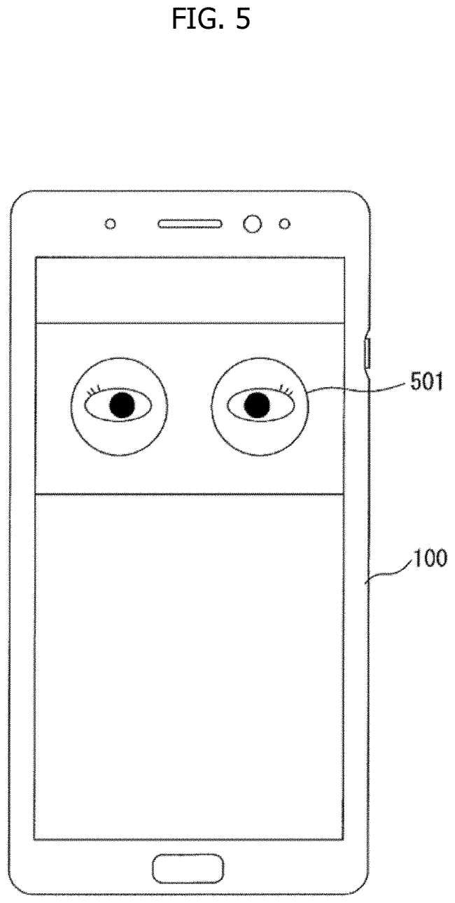

On the other hand, in the iris authentication, the user aligns an eye on a predetermined area within the angle of view of the imaging device 122 included in the iris authentication device 112. For example, as illustrated in FIG. 5, a guide 501 for eye alignment is displayed on the display screen, and the user aligns his eyes on the guide. However, in a case where the user is moving, for example, walking, the information processing device 100 is shaken or the like so that it becomes difficult to meet eyes, and the quality of the iris image collected by the iris authentication device 112 may be reduced. In addition, in an environment with a large amount of light such as under the scorching sun, the imaging device 122 is not able to capture the iris pattern well, and the authentication may fail.

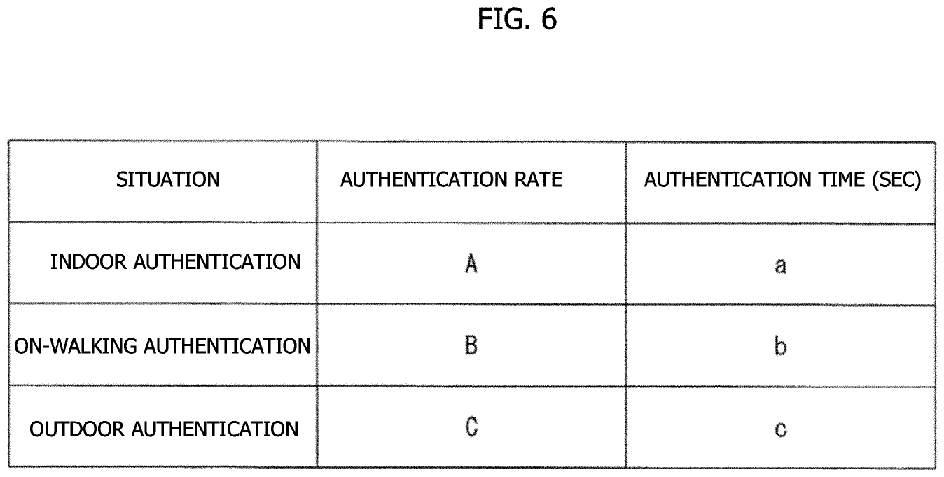

FIG. 6 illustrates an example of the authentication performance according to the situation where the iris authentication is executed. Incidentally, in FIG. 6, the authentication rate represents the success rate of authentication when an authorized user is authenticated, for example. In addition, the authentication time represents the time for authentication when the authorized user authenticates, for example. In addition, in FIG. 6, the authentication rate satisfies the relationship of A>B>C, and the authentication time satisfies the relationship of c>b>a. That is, for example, in an environment where the amount of light is controlled indoors, high authentication rate: A is shown, but during walking, the authentication rate decreases to authentication rate: B, and in the case of the outside with a large amount of light, authentication rate: C lower than authentication rate: B is shown. On the other hand, the authentication time is the shortest as authentication time: a indoors, the authentication time: b during walking is the next shortest, and the authentication time is prolonged as authentication time: c outdoors.

Therefore, for example, the control part 301 may achieve power saving by suppressing activation of the iris authentication device 112 in a situation of the outside or the like with a large amount of light or in a situation where it is difficult to execute eye alignment during walking or the like. Incidentally, the control part 301 may detect a situation where the amount of light is large on the basis of, for example, the illuminance detected by the sensor 303 such as an illuminance sensor to be higher than a predetermined threshold. In addition, the control part 301 may detect a situation in which it is difficult to execute eye alignment during walking or the like on the basis of, for example, whether a change in acceleration observed by the acceleration sensor indicates a predetermined tendency meaning walking. Alternatively, in another example, the control part 301 may estimate that it is difficult to execute eye alignment when an acceleration change greater than or equal to a predetermined value has occurred a predetermined number of times in a predetermined period and suppress activation of the iris authentication device 112 to achieve power saving.

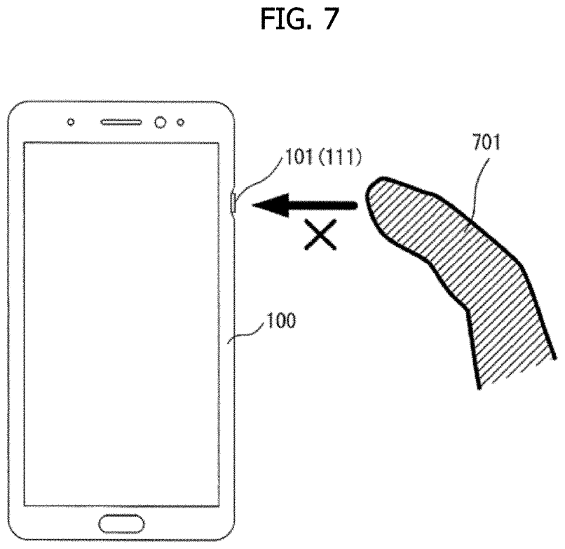

In addition, fingerprint authentication is characterized in that the authentication result is not easily influenced by surrounding environmental factors. On the other hand, fingerprint authentication may fail when the finger is dry or wet. In addition, for example, there are users who work with gloves on for a long time in a factory or work site. For example, as illustrated in FIG. 7, when the user wears gloves 701, the fingerprint cannot be input to the fingerprint authentication device 111 as it is. Therefore, for example, in a situation where the user wears gloves, the control part 301 may suppress the activation of the fingerprint authentication device 111 to achieve power saving.

Incidentally, in the information processing device 100 including the plurality of biometric authentication devices 101, even if some of the biometric authentication devices 101 are suppressed from being activated, the other biometric authentication devices 101 can be activated to use the activated biometric authentication devices 101 to execute authentication. Hereinafter, a first embodiment will be described.

### First Embodiment

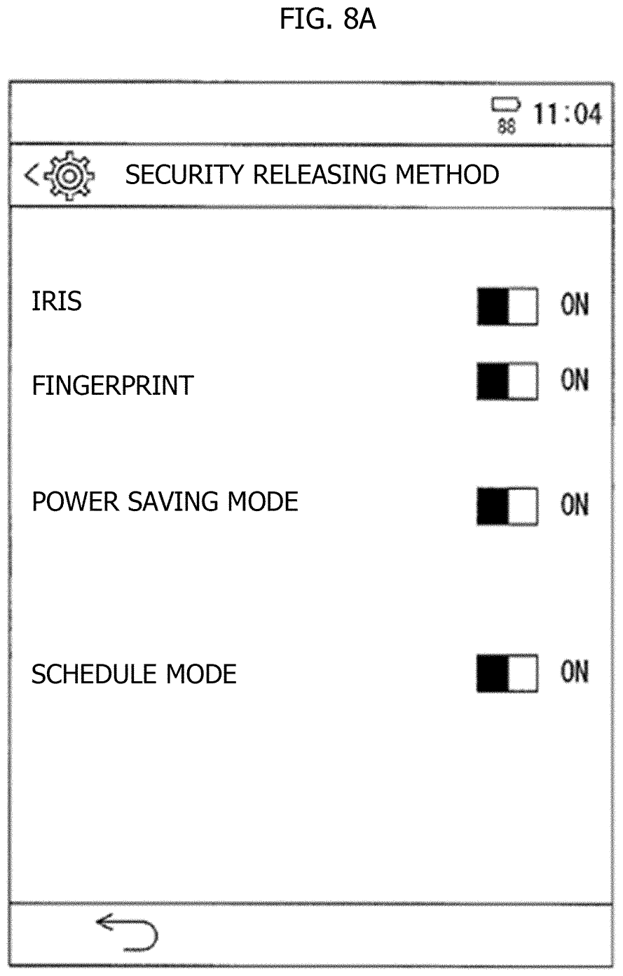

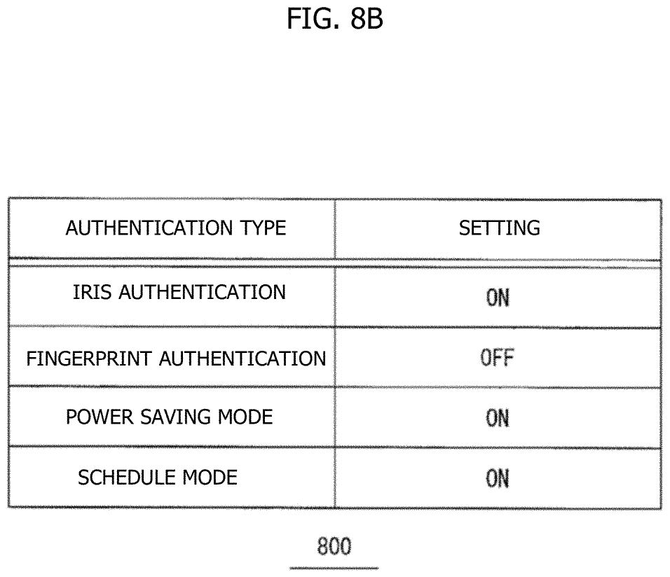

An authentication process according to the first embodiment will be described with reference to FIGS. 8 to 14.

FIGS. 8A and 8B are diagrams illustrating an example of authentication setting according to the embodiment. FIG. 8A illustrates an example of an authentication setting screen according to the embodiment. As illustrated in FIG. 8A, the authentication setting screen according to the embodiment can set ON and OFF of the fingerprint authentication and the iris authentication, and the user manually can switch ON and OFF of the fingerprint authentication device 111 and the iris authentication device 112. Furthermore, in the embodiment, the authentication setting screen automatically switches ON and OFF of the fingerprint authentication device 111 and the iris authentication device 112 according to the situation estimated on the basis of the detection information detected by the sensor at the start of authentication and includes a power saving mode to save power. In the embodiment, the authentication setting screen includes a schedule mode in which the fingerprint authentication device 111 and the iris authentication device 112 are automatically switched ON and OFF according to a schedule set in schedule information 1100 described later. Incidentally, the ON and OFF setting of the fingerprint authentication, the iris authentication, the power saving mode, and the schedule mode set on the authentication setting screen may be stored in the authentication setting information 800 of FIG. 8B.

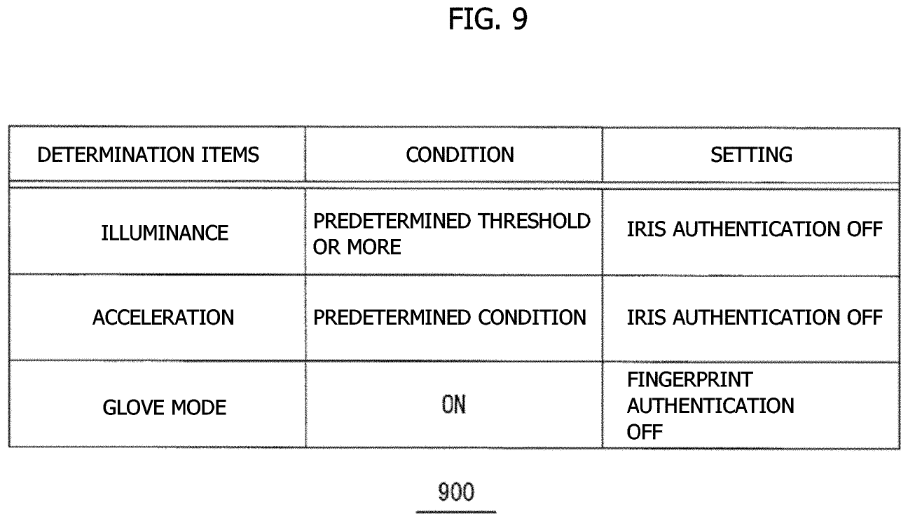

FIG. 9 is a diagram illustrating an example of the condition information 900 that defines ON/OFF switching conditions of the fingerprint authentication device 111 and the iris authentication device 112 in the power saving mode. In the condition information 900, for example, an entry including information on determination items, conditions, and setting may be registered. The determination item indicates information on a determination target. The condition is information for specifying a determination condition. The setting is information indicating the biometric authentication device 101 that is controlled to be OFF in a case where the condition is satisfied in the determination.

For example, an entry in which illuminance is set in the determination item of the condition information 900 indicates that the iris authentication is set to OFF when the illuminance measured by the illuminance sensor is equal to or greater than a predetermined threshold. As described above, in the iris authentication, in an environment with a large amount of light, the quality of information on the iris collected by the iris authentication device 112 deteriorates so that the authentication rate decreases, or the authentication time increases. In this case, the authentication by the iris authentication device 112 might not function sufficiently. Therefore, in a case where the illuminance detected by the illuminance sensor is equal to or greater than a predetermined threshold, the authentication by the iris authentication device 112 might not be performed, and the control part 301 may perform control such that the iris authentication device 112 is not activated at the start of authentication. As a result, the control part 301 can suppress that the iris authentication device 112 is activated to consume power in a situation where authentication by the iris authentication device 112 may fail due to, for example, an environment with a large amount of light. As a result, power can be used efficiently in the authentication process, and power consumption can be suppressed. Incidentally, the predetermined threshold may be set to a value in which the decrease in the authentication rate and the increase in the authentication time are within an allowable range when the illuminance measured by the illuminance sensor is less than the threshold, for example.

For example, an entry in which acceleration is set in the determination item of the condition information 900 indicates that iris authentication is set to OFF when a change in the acceleration measured by the acceleration sensor in a predetermined period satisfies a predetermined condition. Incidentally, for example, there is a technique for detecting whether a user holding the information processing device 100 is walking from a change in acceleration. For example, the predetermined condition may be the change in acceleration indicating that the user is walking. As described above, in the iris authentication, when the user is walking, the eye alignment might not be successful, and the quality of the information on the iris collected by the iris authentication device 112 may deteriorate so that the authentication rate decreases, or the authentication time increases. In this case, the authentication by the iris authentication device 112 might not function sufficiently. Therefore, for example, in a case where it is detected that the user is walking from a change in acceleration measured by the acceleration sensor in a predetermined period at the start of authentication, the authentication by the iris authentication device 112 might not be performed. Then, the control part 301 may perform control such that the iris authentication device 112 is not activated at the start of authentication. As a result, the control part 301 can suppress that the iris authentication device 112 is activated to consume power in a situation where the eye alignment may fail due to user movement, for example. As a result, power can be used efficiently in the authentication process, and power consumption can be suppressed. Incidentally, the predetermined condition is not limited to the condition for detecting that the user is walking. For example, the predetermined condition may be other conditions for detecting a situation where the eye alignment is difficult such as a situation where the user is running to move violently and a situation where the user is driving on a rough road to be shaken greatly.

For example, an entry in which the glove mode is set in the determination item of the condition information 900 indicates that the fingerprint authentication is set to OFF in a case where the glove mode is set to ON in the information processing device 100. For example, the glove mode may be set in the information processing device 100. For example, the glove mode is a detection mode in which the touch detection sensitivity of the touch panel 102 is increased such that the touch panel 102 can detect even the contact of a living body such as a hand through the glove in a state where the user wears gloves.

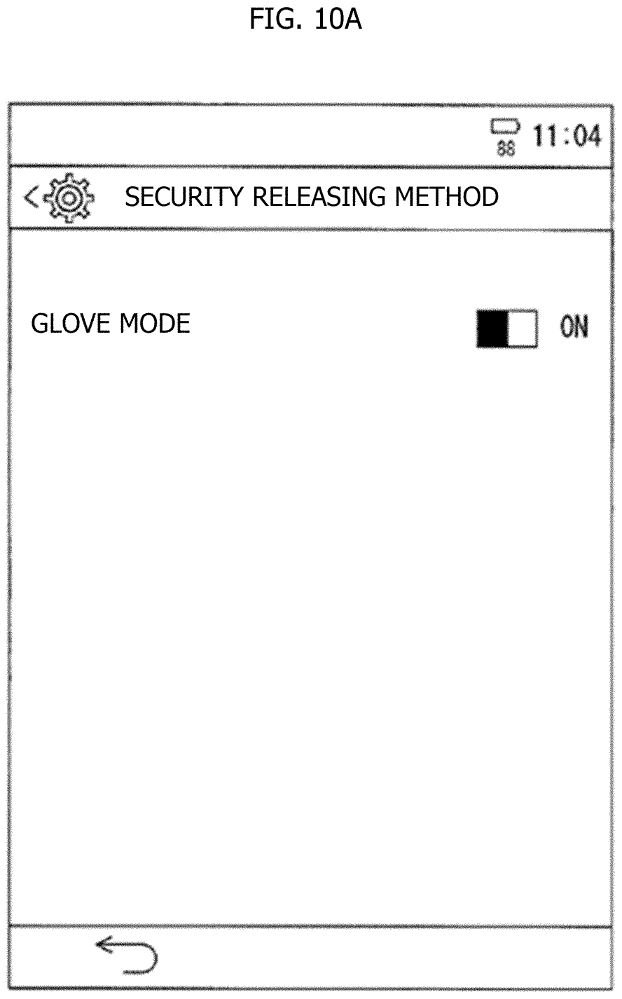

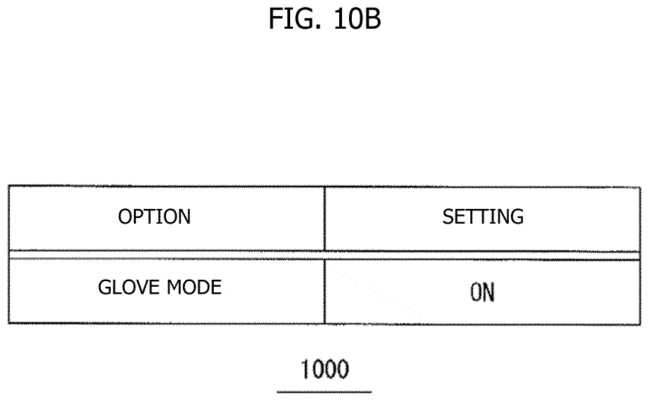

FIGS. 10A and 10B are diagrams illustrating an example of setting of the glove mode. For example, when the user turns on the glove mode on the setting screen of FIG. 10A, the glove mode is set to ON in the mode setting information 1000. In the glove mode, the control part 301 increases the detection sensitivity of touch by the touch panel 102 such that the contact with the touch panel 102 can be detected even in the case of a hand wearing gloves, for example. Herein, in the glove mode, it is estimated that the user wears a glove, but the user cannot input a fingerprint to the fingerprint authentication device 111 in the gloved state. Therefore, for example, the control part 301 may refer to the mode setting information 1000 at the start of authentication and may perform control such that the fingerprint authentication device 111 is not activated in a case where the glove mode is set to ON. Thereby, for example, the control part 301 suppresses that the fingerprint authentication device 111 is activated to consume power in a state where the user wears gloves so that the fingerprint cannot be input to the fingerprint authentication device 111. As a result, power can be used efficiently in the authentication process, and power consumption can be suppressed.

In the first embodiment, for example, the control part 301 may perform control such that any of the plurality of biometric authentication devices 101 included in the information processing device 100 is not activated at the start of authentication according to a schedule.

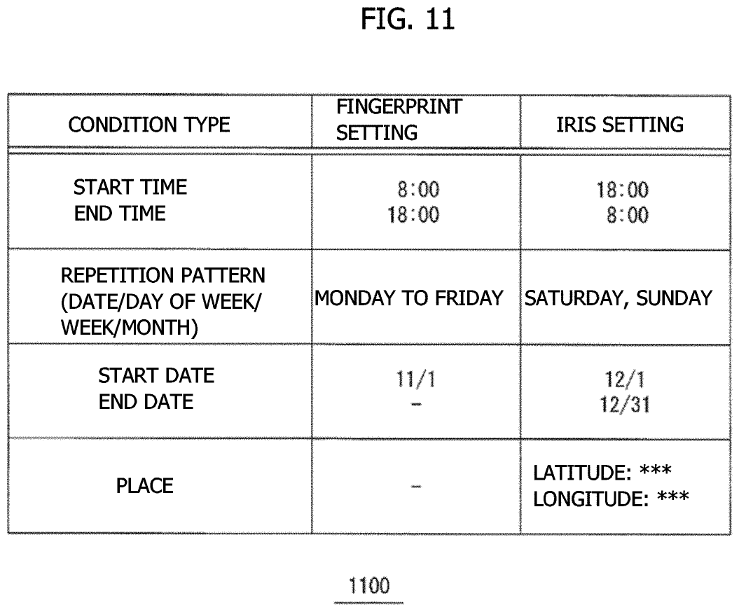

FIG. 11 is a diagram illustrating an example of the schedule information 1100. In the schedule information 1100, for example, for at least one biometric authentication device 101 of the plurality of biometric authentication devices 101, an entry that defines a schedule indicating a date and place to be turned off may be registered. Incidentally, in the example of FIG. 11, a schedule for the fingerprint authentication device 111 and the iris authentication device 112 is registered in the entry. The entry of the schedule information 1100 includes, for example, a condition type, fingerprint setting, and iris setting. The condition type is information indicating the type of condition used to specify a condition for turning off the biometric authentication device 101, for example. In the fingerprint setting, for example, a condition for causing the fingerprint authentication device 111 not to be activated at the start of authentication is set according to the type specified in the condition type of the entry. In addition, in the iris setting, for example, a condition for causing the iris authentication device 112 not to be activated at the start of authentication is set according to the type specified in the condition type of the entry.

For example, in the example of FIG. 11, the condition types that define the conditions include types such as a start time and an end time, a repetition pattern, a start date and an end date, and a place. As illustrated in FIG. 11, the condition in which the fingerprint authentication device 111 or the iris authentication device 112 is not activated at the start of authentication according to the type of a start time and an end time, a repetition pattern, a start date and an end date, a place, or the like is specified for each of the fingerprint setting condition and the iris setting by the user. Incidentally, the control part 301 may perform control such that the fingerprint authentication device 111 or the iris authentication device 112 corresponding to the condition is not activated when the condition specified by the entry is satisfied at the start of authentication.

For example, as described above, according to the embodiment, on the basis of the detection information detected by the sensor 303 or on the basis of the setting of the mode setting information 1000 or the schedule information 1100, the control part 301 may perform control such that the biometric authentication device 101 is not activated at the start of authentication.

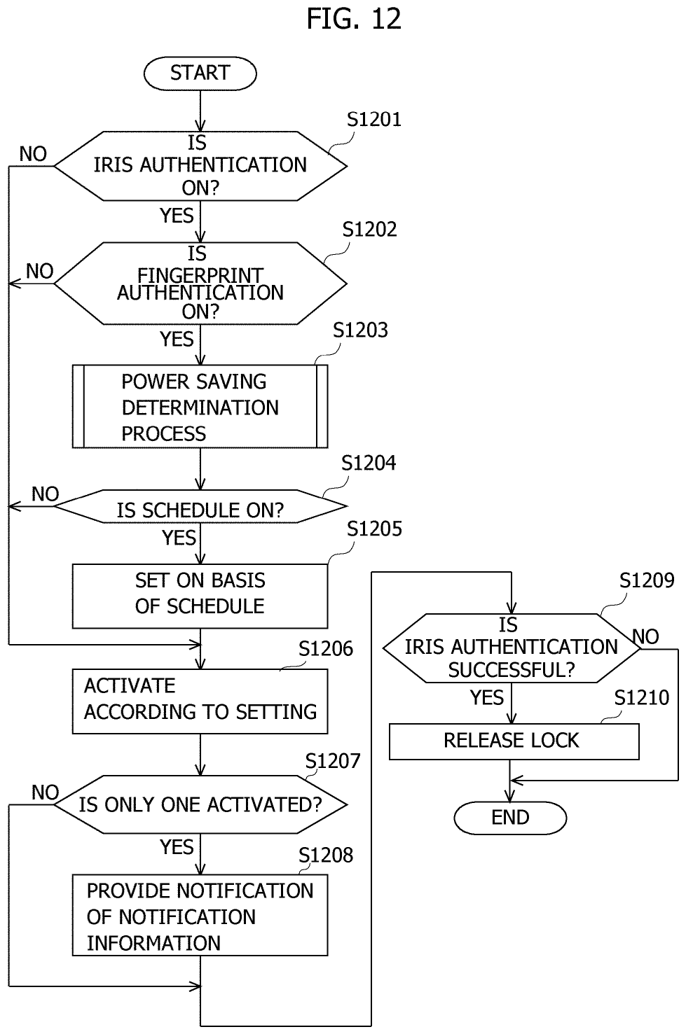

FIG. 12 is a diagram illustrating an example of an authentication process according to the first embodiment. For example, when an instruction to start the lock release of the information processing device 100 is input, the control part 301 may start the operation flow of FIG. 12. For example, the user may input a lock release start instruction to the information processing device 100 by inputting to a hardware key such as a power button or a home key or a software key.

In step 1201 (hereinafter, step is described as “S”, for example, expressed as S1201), the control part 301 refers to the authentication setting information 800 and determines whether or not the iris authentication setting is ON. In a case where the iris authentication setting is OFF (NO in S1201), the flow proceeds to S1206. On the other hand, in a case where the iris authentication setting is ON (YES in S1201), the flow proceeds to S1202.

In S1202, the control part 301 refers to the authentication setting information 800 and determines whether or not the fingerprint authentication setting is ON. In a case where the fingerprint authentication setting is OFF (NO in S1202), the flow proceeds to S1206. On the other hand, in a case where the fingerprint authentication setting is ON (YES in S1202), the flow proceeds to S1203. In S1203, the control part 301 executes a power saving determination process.

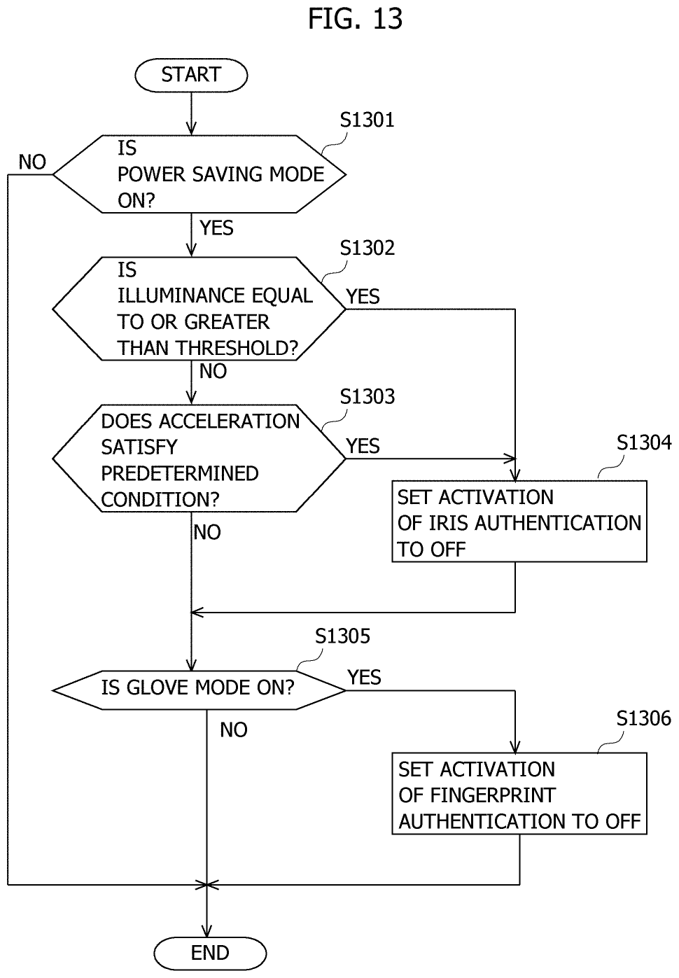

FIG. 13 is a diagram illustrating an example of the power saving determination process according to the embodiment. For example, when the process proceeds to S1203, the control part 301 may start the operation flow of FIG. 13.

In S1301, the control part 301 refers to the authentication setting information 800 and determines whether or not the power saving mode is set to ON. In a case where the power saving mode is set to OFF (NO in S1301), this operation flow ends, and the flow proceeds to S1204 in FIG. 12. On the other hand, in a case where the power saving mode is set to ON (YES in S1301), the flow proceeds to S1302.

In S1302, the control part 301 refers to the entry of the determination item: illuminance in the condition information 900 and determines whether or not the illuminance is equal to or greater than a threshold. In a case where the illuminance is not equal to or greater than the threshold (NO in S1302), the flow proceeds to S1303. On the other hand, in a case where the illuminance is equal to or greater than or equal to the threshold (YES in S1302), the flow proceeds to S1304.

In S1303, the control part 301 refers to the entry of the determination item: acceleration in the condition information 900 and determines whether or not the acceleration detected by the acceleration sensor satisfies a predetermined condition. For example, the predetermined condition may be a condition for detecting the walking state of the user on the basis of the acceleration. In another embodiment, the predetermined condition is, for example, a condition for detecting a state in which the eye alignment is difficult (for example, the acceleration per unit time fluctuates a predetermined number of times with a magnitude greater than a predetermined threshold to be shaken) from acceleration. In a case where the acceleration does not satisfy the predetermined condition (NO in S1303), the flow proceeds to S1305. On the other hand, in a case where the acceleration detected by the acceleration sensor satisfies the predetermined condition (YES in S1303), the flow proceeds to S1304.

In S1304, the control part 301 sets the iris authentication setting of the authentication setting information 800 to OFF. Therefore, for example, it can be suppressed in S1206 (to be described later) that the iris authentication device 112 is activated in a situation where the illuminance is high or eye alignment is difficult so that the quality of information on the iris collected by the iris authentication device 112 deteriorates. When the process of S1304 is executed, the flow proceeds to S1305.

In S1305, the control part 301 refers to the entry of the determination item: glove mode in the condition information 900 and determines whether or not the glove mode is set to ON in the mode setting information 1000. In a case where the glove mode is set to ON (YES in S1305), the flow proceeds to S1306. In S1306, the control part 301 sets the fingerprint authentication of the authentication setting information 800 to OFF and this operation flow ends. Therefore, for example, it can be suppressed in S1206 (to be described later) that the fingerprint authentication device 111 is activated in a situation where the user wears gloves, and the fingerprint authentication is difficult to execute.

In a case where the glove mode is OFF in S1305 (NO in S1305), the operation flow ends, and the flow proceeds to S1204 in FIG. 12.

In S1204, the control part 301 refers to the authentication setting information 800 and determines whether or not the schedule mode is ON. In a case where the schedule mode is OFF (NO in S1204), the flow proceeds to S1206. On the other hand, in a case where the schedule mode is ON (YES in S1204), the flow proceeds to S1205.

In S1205, the control part 301 refers to the schedule information 1100, and sets the authentication setting information 800 according to the schedule that is satisfied at the start of authentication for lock release. For example, when the time at the start of authentication for lock release is between 8:00 and 18:00 indicated in the fingerprint setting of the condition type: start time and end time, the control part 301 may set the fingerprint authentication of the authentication setting information 800 to OFF. In addition, for example, when the position of the information processing device 100 at the start of authentication for lock release is within a predetermined distance from the position indicated by the condition type: place in the schedule information 1100, the control part 301 may set the iris authentication of the authentication setting information 800 to OFF. Therefore, the user registers the schedule that does not use some of the biometric authentication devices 101 provided in the information processing device 100 in the schedule information 1100, thereby suppressing the activation of the biometric authentication device 101 that is not used in S1206 below.

In S1206, the control part 301 refers to the iris authentication and the fingerprint authentication of the authentication setting information 800 and activates the biometric authentication device 101 according to the setting. For example, the control part 301 may activate the iris authentication device 112 when the iris authentication is set to ON and does not activate the iris authentication device 112 when the iris authentication is set to OFF. Further, the control part 301 may activate the fingerprint authentication device 111 when the fingerprint authentication is set to ON and might not activate the fingerprint authentication device 111 when the fingerprint authentication is set to OFF.

In S1207, the control part 301 determines whether only one of the iris authentication and the fingerprint authentication is activated. In a case where both are activated (NO in S1207), the flow proceeds to S1209. On the other hand, in a case where when only one of the iris authentication and the fingerprint authentication is activated (YES in S1207), the flow proceeds to S1208. In S1208, the control part 301 provides notification of notification information indicating that only one biometric authentication device 101 is activated.

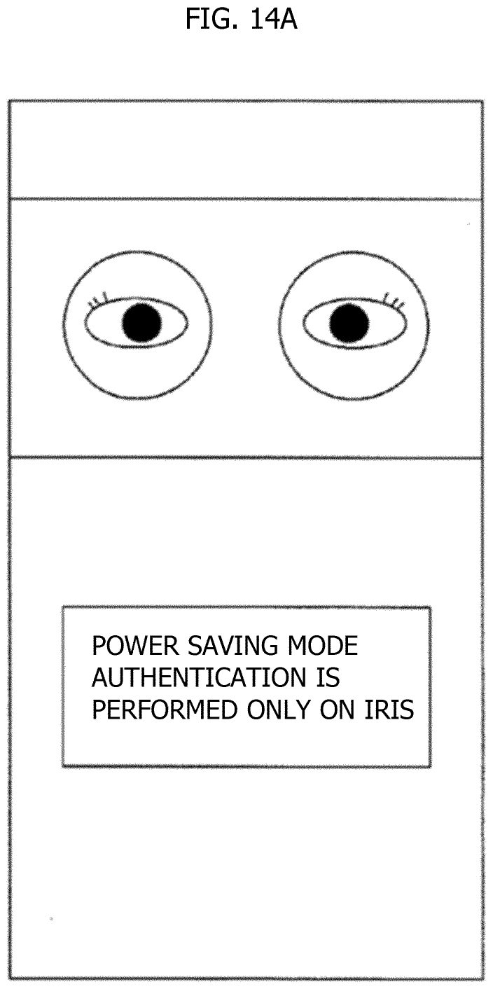

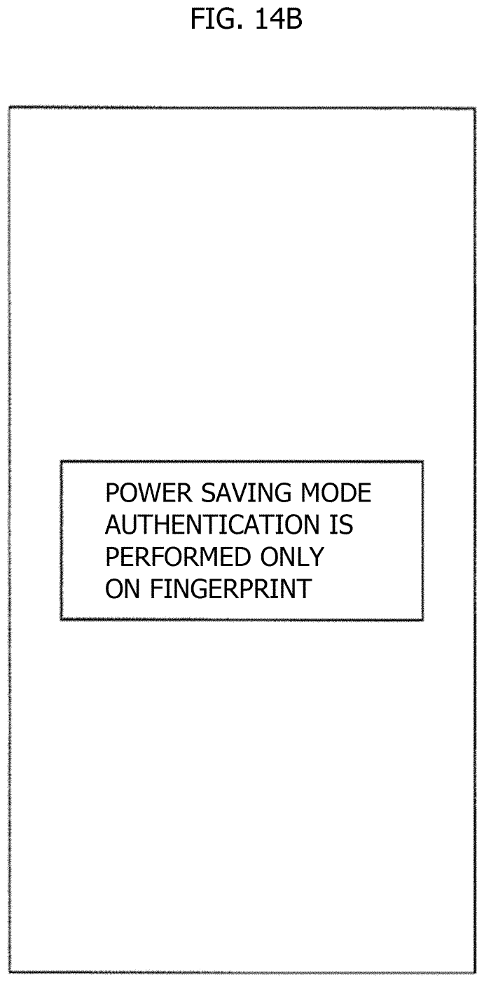

FIGS. 14A and 14B are diagrams illustrating an example of the notification information. FIG. 14A illustrates an example of the notification information in a case where only the iris authentication device 112 is activated in the iris authentication and the fingerprint authentication and illustrates that only the iris authentication can be used. In addition, FIG. 14B illustrates an example of the notification information in a case where only the fingerprint authentication device 111 is activated in the iris authentication and the fingerprint authentication and illustrates that only the fingerprint authentication can be used. By viewing the notification information, the user can know that, for example, only one authentication can be used. Therefore, it is possible to know that there is no abnormality in the information processing device 100 even if an authentication method that is not activated cannot be used.

In S1209, the control part 301 waits for the biometric information to be input to the activated biometric authentication device 101, executes authentication using the input biometric information, and determines whether or not the authentication is successful. In a case where the authentication fails (NO in S1209), this operation flow ends. On the other hand, in a case where the authentication is successful (YES in S1209), the flow proceeds to S1210. In S1210, the control part 301 releases the lock of the information processing device 100, and the operation flow ends.

As described above, in the first embodiment, on the basis of the detection information detected by the sensor 303, some biometric authentication devices 101 among the plurality of biometric authentication devices 101 are caused not to be activated. Therefore, for example, in a case where it is estimated from the detection information detected by the sensor 303 that the situation is not suitable for collecting the biometric information by some biometric authentication devices 101, it is possible to suppress that the biometric authentication device 101 is activated to consume power.

For example, the quality of information on the iris collected by the iris authentication device 112 may be reduced due to the environment with a large amount of light. Therefore, in the above-described first embodiment, in a case where the illuminance detected by the illuminance sensor is equal to or greater than a predetermined threshold, the control part 301 performs control such that the iris authentication device 112 is not activated at the start of authentication. Thereby, waste of power by the iris authentication device 112 can be reduced.

In addition, in a situation where eye alignment is difficult, for example, in a case where the user is walking, the quality of information on the iris collected by the iris authentication device 112 may be reduced. Therefore, in the above-described first embodiment, in a case where the acceleration detected by the acceleration sensor indicates a situation where eye alignment is difficult, for example, the walking state of the user, the control part 301 performs control such that the iris authentication device 112 is not activated at the start of authentication. Thereby, waste of power by the iris authentication device 112 can be reduced.

For example, in a state where the user wears gloves, the fingerprint cannot be input to the fingerprint authentication device 111. Therefore, in the above-described first embodiment, in a case where the glove mode is ON in the mode setting information 1000, the control part 301 performs control such that the fingerprint authentication device 111 is not activated at the start of authentication. Thereby, waste of power by the fingerprint authentication device 111 can be reduced.

In the above-described embodiment, for example, in a case where the user does not plan to use some biometric authentication devices 101 provided in the information processing device 100, the user registers the scheduled information in the schedule information 1100. Then, by referring to the schedule information 1100, the biometric authentication device 101 scheduled not to be used at the start of authentication is caused not to be activated. Therefore, it is possible to avoid that the biometric authentication device 101 that is unlikely to be used is activated to waste power.

In the above-described embodiment, in a case where some biometric authentication devices 101 provided in the information processing device 100 are not activated, the notification information notifies that only the remaining biometric authentication devices 101 can be used. Therefore, for example, the user can know that there is no abnormality in the information processing device 100 even if some authentication methods cannot be used.

As described above, according to the first embodiment, power can be efficiently used in the authentication process.

Incidentally, in a case where either the power saving mode or the schedule mode of the authentication setting information 800 is set to ON at the start of the execution of the authentication process of FIG. 12, the control part 301 may set the iris authentication and the fingerprint authentication of the authentication setting information 800 to ON before executing the process of S1201.

### Second Embodiment

In the first embodiment, the example is described in which some biometric authentication devices 101 among the plurality of biometric authentication devices 101 are caused not to be activated on the basis of the situation estimated from the detection values and setting of the sensor 303 at the start of authentication, the schedule, and the like, so as to achieve power saving. However, the embodiments are not limited thereto, and further power saving may be achieved. In a second embodiment, for example, in a case where the iris authentication device 112 is caused not to be activated, and the fingerprint authentication device 111 executes authentication, power saving is further achieved by suppressing display on the display device 304, for example, by turning off the display device 304.

For example, this is because a guide indicating the contact portion of a living body with irregularities such as depressions and protrusions is formed in the casing of the information processing device 100 in a case where the user inputs biometric information by bringing the living body into contact with the biometric authentication device 101 as in the fingerprint authentication or the like.

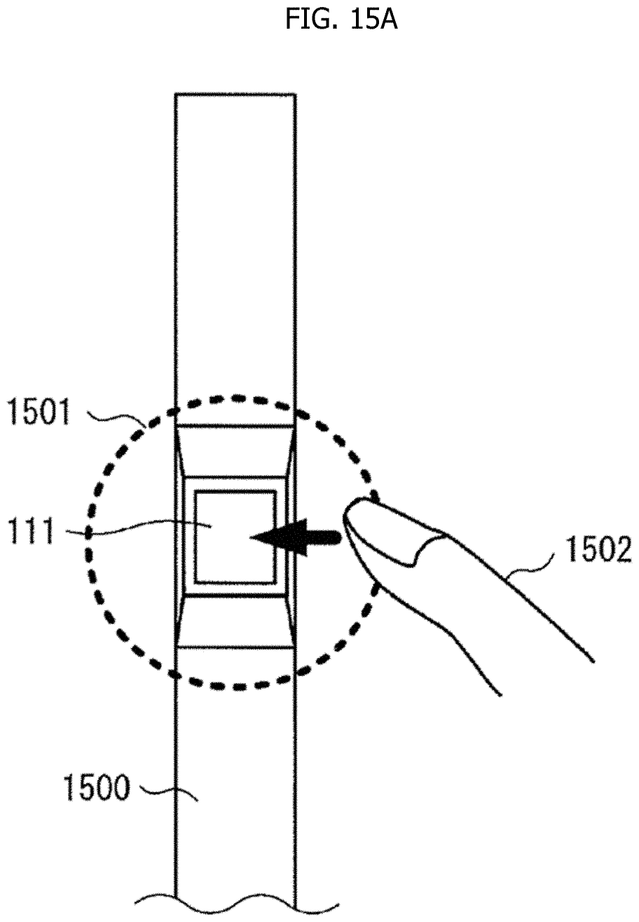

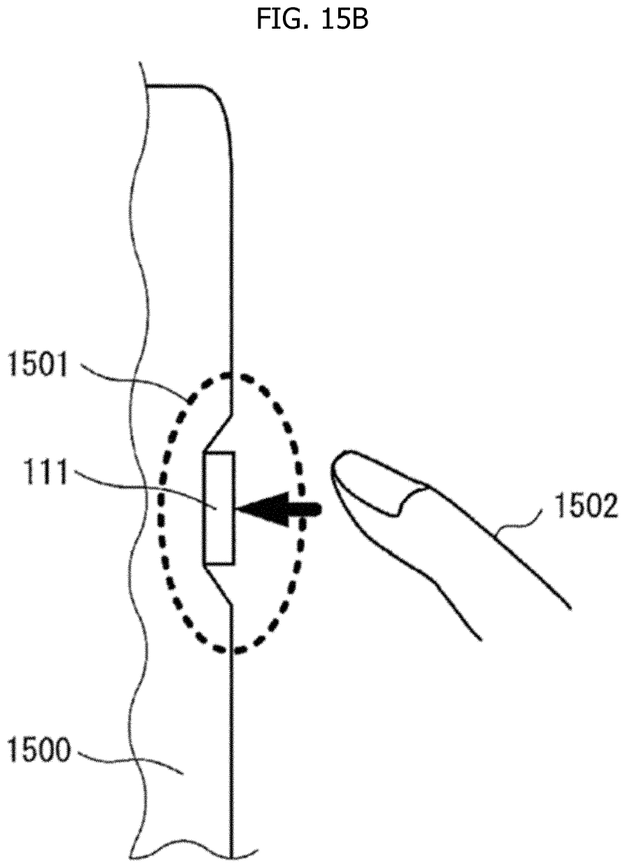

FIGS. 15A and 15B are diagrams illustrating an example of a guide 1501 indicating a portion to be contacted by a finger. FIGS. 15A and 15B are diagrams illustrating a peripheral region of the fingerprint authentication device 111 provided in a casing 1500 of the information processing device 100 from the front (FIG. 15A) and from the side (FIG. 15B).

The casing 1500 is provided with the fingerprint authentication device 111 that is a target for inputting biometric information by bringing a finger 1502 into contact therewith. Further, the guide 1501 indicating the contact portion of the finger 1502 with a depression is formed in the peripheral region of the fingerprint authentication device 111. In a case where the guide 1501 is formed, the user can recognize that the contact point of the finger 1502 is the position of the guide 1501 even when the information indicating the portion to be contacted by a living body is not displayed on the display screen. Therefore, for example, the display device 304 is turned off to suppress display on the display device 304, thereby reducing power consumption.

Incidentally, for example, in the iris authentication, the biometric information is input in a non-contact manner by imaging the eyes of the user with the imaging device 122. It is preferable to display the guide 501 on the display device 304 for the eye alignment of the user since, for example, the position of the eye can be confirmed with the guide 501 as illustrated in FIG. 5.

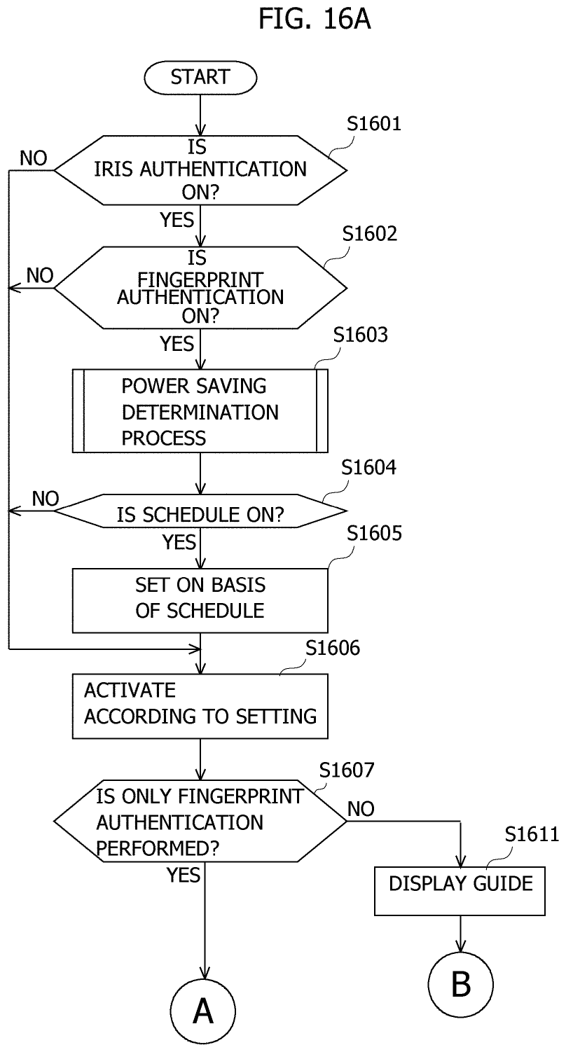

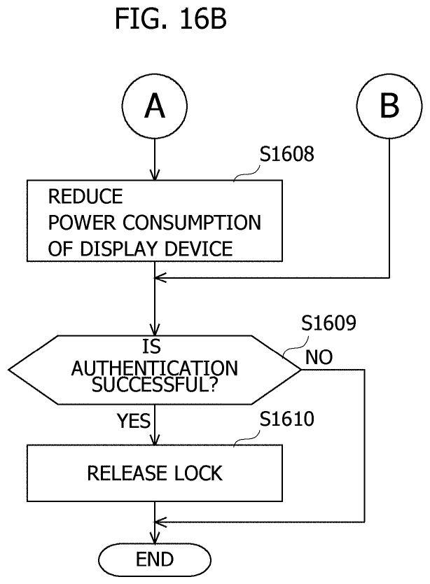

FIGS. 16A and 16B are diagrams illustrating an example of an authentication process according to the second embodiment. For example, when an instruction to start the lock release of the information processing device 100 is input, the control part 301 may start the operation flow of FIGS. 16A and 16B. For example, the user may input a lock release start instruction to the information processing device 100 by inputting to a hardware key such as a power button or a home key or a software key.

Incidentally, the operation flow in FIGS. 16A and 16B corresponds to the operation flow in FIG. 12. For example, in the processes from S1601 to S1606, the control part 301 may execute the same processes as the processes from S1201 to S1206.

In S1607, the control part 301 determines whether or not only the fingerprint authentication device 111 is activated in S1606. In a case where only the fingerprint authentication device 111 is activated (YES in S1607), the flow proceeds to S1608. In S1608, the control part 301 suppresses display on the display device 304 by turning off the display device 304, for example. Therefore, the power consumption of the display device 304 can be reduced. When the power consumption of the display device 304 is reduced, the flow proceeds to S1609.

On the other hand, in a case where the iris authentication device 112 is also activated in S1607 (NO in S1607), the flow proceeds to S1611. In S1611, the control part 301 displays a guide indicating the authentication method on the display screen of the display device 304, and the flow proceeds to S1609.

Subsequently, the processes of S1609 and S1610 may correspond to the processes of S1209 and S1210 in FIG. 12, and in one example, in the processes of S1609 and S1610, the control part 301 may execute the same processes as the processes of S1209 and S1210. When the process of S1610 is completed, this operation flow ends.

In the second embodiment, in a case where the activated biometric authentication device 101 has only, for example, an authentication method of using biometric contact with the casing 1500 of the fingerprint authentication device 111 or the like, the display device 304 is turned off to suppress display on the display device 304, thereby reducing power consumption. Therefore, power saving can be further achieved in addition to the effects exhibited by the first embodiment.

Although the embodiments have been illustrated above, the embodiments are not limited thereto. For example, the above-described operation flow is an example, and the embodiments are not limited thereto. If possible, the operation flow may be executed by changing the order of processes and may include an additional process, or some of the processes may be omitted. For example, the processes of S1201 and S1202 in FIG. 12 and the processes of S1601 and S1602 in FIG. 16A may be executed with the order changed. In addition, for example, in another embodiment, one of the process of S1203 and the processes of S1204 and S1205 may be omitted.

In the above-described embodiments, an example is described in which the conditions for not activating the biometric authentication device 101 are set in the condition information 900 and the schedule information 1100. However, the embodiments are not limited thereto. In another embodiment, a condition for activating the biometric authentication device 101 may be set. Further, for example, a priority order may be set such that one of the condition information 900 and the schedule information 1100 is prioritized.

In the above-described embodiments, the authentication at the time of lock release of the information processing device 100 is described as an example, but the embodiments are not limited thereto. For example, in another embodiment, the embodiments may be applied to other authentication such as authentication at the time of login to an application or service.

In the above-described embodiment, the fingerprint authentication and the iris authentication are described as examples of the biometric authentication device 101. However, the embodiments are not limited thereto. For example, the embodiments can be applied to other authentication methods such as vein authentication, palm authentication, and face authentication.

As an example, it is assumed that the information processing device 100 includes the infrared light emitting diode 121 and the imaging device 122 and can execute both iris authentication and face authentication. Herein, in the face authentication, when the illuminance decreases, the authentication accuracy decreases. On the other hand, the face authentication can be executed even with high illuminance. For example, in this case, at high illuminance where the accuracy of the iris authentication is reduced, the infrared light emitting diode 121 is set to OFF, and the face authentication is executed, thereby reducing the power consumed by the infrared light emitting diode 121 to achieve power saving.

For example, in the vein authentication and the palm authentication, the input of biometric information may involve the contact of the living body, and the guide 1501 may be formed to be with unevenness or the like on the casing 1500 of the information processing device 100. Therefore, when the vein authentication or the palm authentication is used, it is possible to obtain an effect of saving power of the display device 304 of the second embodiment.

Incidentally, in the above-described embodiments, for example, the control part 301 may operate as the activation control part 311 in the processes from S1201 to S1208 in FIG. 12 and the processes from S1601 to S1608 and S1611 in FIGS. 16A and 16B. In addition, for example, in the processes of S1209 in FIG. 12 and S1609 in FIG. 16B, the control part 301 may operate as the authentication part 312.

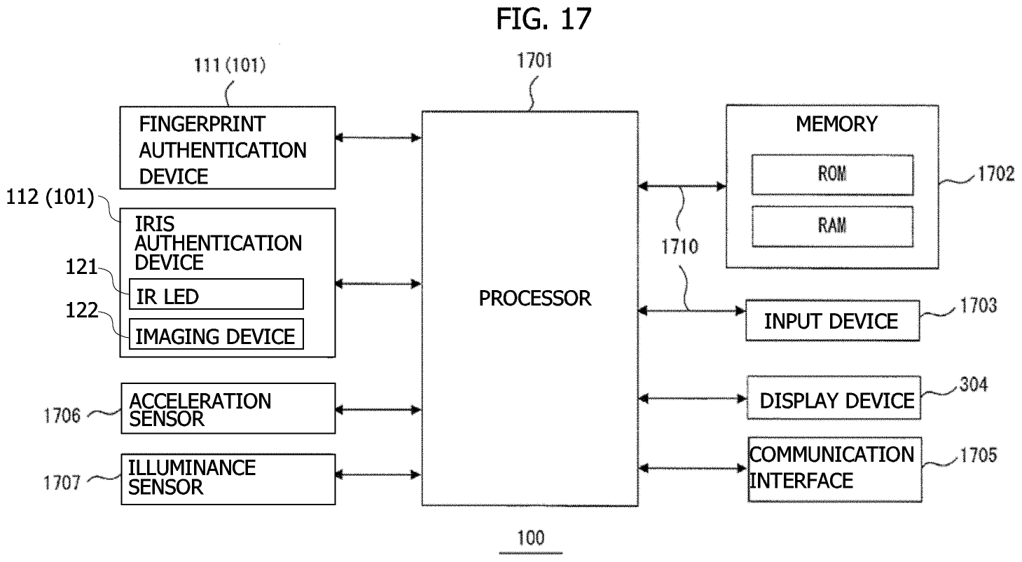

FIG. 17 is a diagram illustrating an example of a hardware configuration of a computer for realizing the information processing device 100 according to the embodiment. The hardware configuration of FIG. 17 includes, for example, a processor 1701, a memory 1702, an input device 1703, a display device 304, a communication interface 1705, a fingerprint authentication device 111, an iris authentication device 112, an acceleration sensor 1706, and an illuminance sensor 1707. Incidentally, the memory 1702, the input device 1703, the display device 304, and the communication interface 1705 may be connected to the processor 1701 via a bus 1710, for example. In addition, the fingerprint authentication device 111, the iris authentication device 112, the acceleration sensor 1706, and the illuminance sensor 1707 may be connected to the processor 1701 via the bus 1710, for example.

The processor 1701 executes, for example, a biometric authentication control program describing the procedure of the above-described operation flow using the memory 1702, so as to provide a part or all of the functions of each part including the control part 301 described above. For example, the processor 1701 is operated as an activation control part 311 and an authentication part 312 by reading and executing the biometric authentication control program on the memory 1702.

The memory 1702 is a semiconductor memory, for example, and may include a RAM area and a ROM area. Incidentally, RAM is an abbreviation for Random Access Memory. ROM is an abbreviation for Read Only Memory. The storage part 302 described above may be the memory 1702, for example. For example, the memory 1702 may store the authentication setting information 800, the condition information 900, the mode setting information 1000, and the schedule information 1100.

For example, the input device 1703 is a device such as a hardware key or a touch sensor that receives an input from the user. For example, the display device 304 is a device that displays information such as a display. Incidentally, the display device 304 and the input device 1703 may be implemented as an integrated touch panel 102.

The communication interface 1705 transmits and receives data to and from an external device in accordance with the instruction of the processor 1701, for example. For example, the fingerprint authentication device 111 receives input of information on the fingerprint from a user and outputs the input to the processor. For example, the iris authentication device 112 receives input of information on the iris from a user and outputs the input to the processor. For example, the iris authentication device 112 may include the infrared light emitting diode 121 and the imaging device 122.

For example, the acceleration sensor 1706 measures acceleration. For example, the illuminance sensor 1707 measures illuminance. Incidentally, the acceleration sensor 1706 and the illuminance sensor 1707 are examples of the sensor 303 described above, for example.

Incidentally, the hardware configuration of the computer for realizing the information processing device 100 described with reference to FIG. 17 is an example, and the embodiments are not limited thereto. For example, the information processing device 100 may include other sensors 303 such as a vein authentication device and may include a reading device for accessing a portable storage medium such as an SD card. In addition, in another embodiment, a part or all of the function of the functional parts described above may be implemented as hardware using an FPGA, a SoC, or the like. Incidentally, the FPGA is an abbreviation for Field Programmable Gate Array. The SoC is an abbreviation of System-on-a-chip.

Hereinbefore, several embodiments are described. However, the embodiments are not limited to the above-described embodiments, but may be understood as including various modifications and alternatives of the above-described embodiments. For example, it may be understood that the components of the various embodiments can be modified and embodied without departing from the spirit and scope of the invention. In addition, it may be understood that various embodiments can be implemented by appropriately combining a plurality of components disclosed in the above-described embodiments. Furthermore, it may be understood by a person skilled in the art that several components may be removed or replaced from all components described in the embodiment, or that several components may be added to the components described in the embodiment to perform various embodiments.

In the information processing device including the plurality of biometric authentication devices, power consumption during authentication can be suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a sensor;
a memory; and
a processor coupled to the memory and the processor configured to:
perform control such that some biometric authentication devices of a plurality of biometric authentication devices are not activated at start of execution of biometric authentication on a basis of detection information detected by the sensor and activates remaining biometric authentication devices except the some biometric authentication devices of the plurality of biometric authentication devices; and
execute the biometric authentication using the remaining biometric authentication devices.

2. The information processing device according to claim 1, wherein
the sensor is an acceleration sensor,
the plurality of biometric authentication devices includes an iris authentication device, and
the processor is further configured to perform control such that the iris authentication device is not activated at start of execution of the biometric authentication in a case where it is detected on a basis of an acceleration detected by the sensor that a user holding the information processing device is walking.

3. The information processing device according to claim 1, wherein
the sensor is an illuminance sensor,
the plurality of biometric authentication devices includes an iris authentication device, and
the processor is further configured to perform control such that the iris authentication device is not activated at the start of execution of the biometric authentication in a case where illuminance detected by the sensor is equal to or greater than a predetermined threshold.

4. The information processing device according to claim 1, further comprising:
a touch panel, wherein
the plurality of biometric authentication devices includes a fingerprint authentication device, and
the processor is further configured to perform control such that the fingerprint authentication device is not activated at the start of execution of the biometric authentication in a case where a detection mode by the touch panel is set to a glove mode having a detection sensitivity enabling a hand contact to be detected through a glove.

5. The information processing device according to claim 1, wherein:
the memory stores schedule information that defines a condition for suppressing activation of a certain biometric authentication device among the plurality of biometric authentication devices by information indicating date and time or information indicating a place, and
the processor is further configured to perform control such that the certain biometric authentication device is not activated at the start of execution of the biometric authentication in a case where the condition defined in the schedule information is satisfied.

6. The information processing device according to claim 2, further comprising:
a display device, wherein
the processor is further configured to suppress display on the display device in a case of performing control such that the iris authentication device is not activated.

7. A biometric authentication control method executed by an information processing device, the biometric authentication control method comprising:
performing control such that some biometric authentication devices of a plurality of biometric authentication devices are not activated at start of execution of biometric authentication on a basis of detection information detected by a sensor;
activating remaining biometric authentication devices except the some biometric authentication devices of the plurality of biometric authentication devices; and
executing the biometric authentication using the remaining biometric authentication devices.

8. A non-transitory computer-readable recording medium having stored therein a biometric authentication control program of an information processing device including a processor, the control program to cause the processor to:
perform control such that some biometric authentication devices of a plurality of biometric authentication devices are not activated at start of execution of biometric authentication on a basis of detection information detected by a sensor;
activate remaining biometric authentication devices except the some biometric authentication devices of the plurality of biometric authentication devices; and
execute the biometric authentication using the remaining biometric authentication devices.
